(19) United States
(12) Patent Application Publication
(10) Pub. No.: US 2002/0194935 A1
(43) Pub. Date: Dec. 26, 2002

(54) Tensile load sensing belt

(76) Inventors: Arthur Clarke, Dumfries and Galloway (GB); Hans-Dieter Metzen, Juelich (DE)

Correspondence Address: Jeffrey Thurnau, The Gates Corporation, Mail Stop 31-4-1-A3, 900 S. Broadway, Denver, CO, 80209, US

(21) Appl. No.: 09/893,215

(22) Filed: Jun. 26, 2001

(51) Int. Cl. G01L 1/26

(52) U.S. Cl. 73/862.391

(57) ABSTRACT

The invention comprises a lifting belt having at least one tensile member adapted to function as a sensor and a load bearing member. The belt comprises an insulating elastomeric body in which the tensile member is enclosed. The tensile member comprises a series electrical circuit connected to a bridge circuit for detecting resistance changes in the tensile member caused by a strain in the tensile member.

### FIELD OF THE INVENTION

The invention relates to load bearing lifting belts, in particular, to a tensile load sensing lifting belt for connecting to a circuit for detecting a strain change in a tensile member.

### BACKGROUND OF THE INVENTION

Lifting belts generally comprise a tensile member contained within an elastomeric outer covering. The belt tensile member is for the most part used solely to provide the means of supporting the weight to be lifted.

Prior art wire ropes are available that combine a sensor and load bearing capability. These use the wire rope tensile members as strained elements in combination with a voltage bridge for measuring a strain in the tensile member. However, these wire ropes are not continuous and comprise a plurality of parallel conductors that are connected to attachment ends of the rope. They also comprise connectors at each end whereby the rope is connected to a load.

Representative of the art is U.S. Pat. No. 3,958,455 (1976) to Russell which discloses a transducer of the resistance wire rope type wherein strained resistance wires are adapted to function both as a sensor and load bearing member.

Also representative of the art is U.S. Pat. No. 3,950,984 (1976) to Russell which discloses a transducer of the resistance wire rope type wherein strained resistance wires are adapted to function both as a sensor and load bearing member.

What is needed is a lifting belt having a tensile member having a resistance used as a sensor and load bearing member enclosed in a dielectric elastomeric body. The present invention meets this need.

### SUMMARY OF THE INVENTION

The primary aspect of the invention is to provide a lifting belt having a tensile member having a resistance used as a sensor and load bearing member enclosed in a dielectric elastomeric body.

Other aspects of the invention will be pointed out or made obvious by the following description of the invention and the accompanying drawings.

The invention comprises a lifting belt having at least one tensile member adapted to function as a sensor and a load bearing member. The tensile member has a predetermined resistance. The belt comprises an electrically insulating elastomeric body in which the tensile member is enclosed. The tensile member comprises a portion of a series electrical circuit connected to a bridge circuit for detecting resistance changes in the tensile member caused by a strain in the tensile member.

### BRIEF DESCRIPTION OF THE DRAWINGS

FIG. 1 is a schematic view of the inventive system.

FIG. 2 is a cross-sectional view of the belt.

FIG. 3 is a cross-sectional view at line 3-3 in FIG. 1.

FIG. 4 is a graph of the resistance of a tensile member versus belt tension.

FIG. 5 is a sectional perspective view of an alternate embodiment.

### DETAILED DESCRIPTION OF THE PREFERRED EMBODIMENT

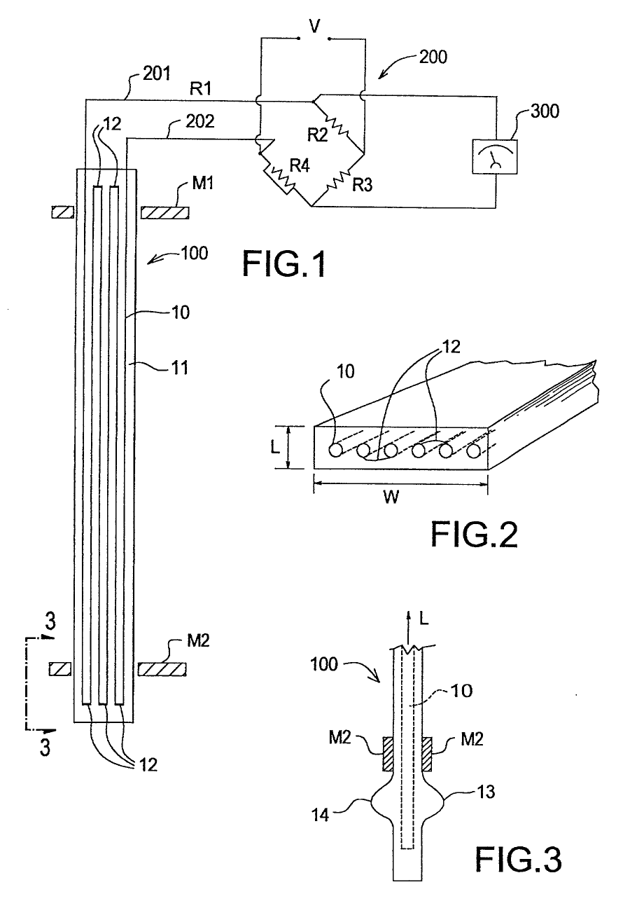

FIG. 1 is a schematic view of the inventive system. Belt 100 comprises tensile cords running the full length of the belt along a major axis. Tensile cords 10 are embedded in elastomeric material 11 in such a way so as to prevent contact between adjacent cords 10 along the length of the belt.

Each tensile cord is connected in series to the next cord at alternate ends of the belt to form a series circuit. Leads 201 and 202 extend from an end of belt 100 for connecting to a Wheatstone bridge 200 or other four arm or two arm voltage/resistance bridge. A meter or other appropriate output display 300 can be connected across the bridge to provide a visual reading of a voltage across the bridge and thereby across the tensile member.

Tensile cords 10 comprise metallic wires or cords that bear and support a load. Cords 10 are electrically conductive.

Alternatively, a single conductive tensile cord 10 may extend along the length of the belt to which leads 200 and 201 are connected at each end in the manner described herein. The single conductive tensile cord would be used in conjunction with other conductive or non-conductive tensile cords, depending on the load bearing requirements of the belt.

Elastomeric 11 may comprise any one of a number of known elastomer compositions known in the art including but not limited to chloroprene rubber or EPDM. Elastomeric 11 is dielectric in order to electrically insulate each tensile cord from the others along the length of the belt body. A dielectric constant, εᵣ, for the elastomeric is in the range of 1.5 to 10.0.

Resistors R2, R3, and R4 have known resistance values and R1 is a resistance of the tensile cord series circuit. A change in the tension/strain or a break in the tensile cord circuit will affect R1, thereby changing a voltage V across the bridge. The change would register on display 300.

The magnitude of R1 is first measured in the unstressed or unloaded condition. R4 is then adjusted to balance the bridge in the unstressed condition. Then, as the belt is loaded, the strain changes the resistivity of the tensile cords, causing a voltage V to change. The voltage change may include registration of strain up to and including total failure of one or all of the tensile cords. One can appreciate that failure of a single tensile cord on the circuit will cause resistance R1 to approach ∞ ω. This will result in a marked change in voltage V across the bridge, alerting a user who can then take the equipment out of service or make repairs.

In service, belt 100 is clamped at each end by mounting bracket M1 and M2. Each mounting bracket grips the belt body, thereby affixing it to a cable drum or elevator car or other piece of equipment. In the preferred embodiment the belt has discrete ends to which the mounting brackets are clamped, such as in the case of a rope, as opposed to an endless belt.

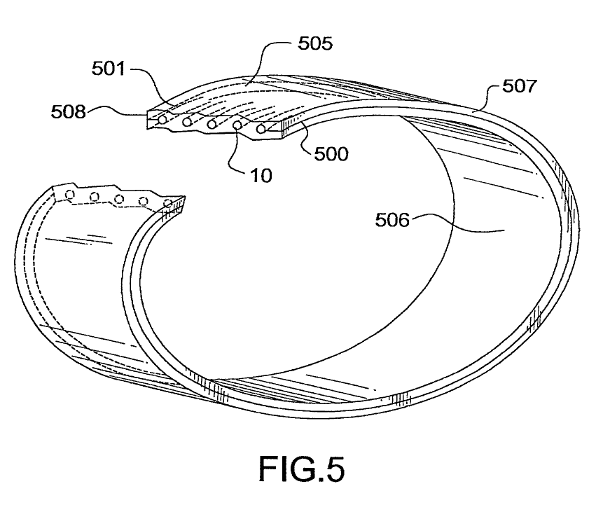

In an alternate embodiment the belt comprises an endless or continuous member, also operating in a lifting capacity. In the alternate embodiment leads 201 and 202 project from a side of the belt body, or the leads extend along a side of the continuous belt as shown in FIG. 5. The tensile cords 10 are connected in series as described herein with the side leads 500, 501 located on the sides of the belt, 507, 508 respectively, for connecting the belt to the bridge circuit. Leads 500, 501 contact a conductor for receiving a voltage signal, such as conductive pulley flanges (not shown) during operation. The leads 500, 501 would be operationally similar to electric motor brushes in this way, electrically connecting to the pulley flanges during each pass through a pulley. Leads 500, 501 may also extend or project along sides 505 and 506. The belt leads would again comprise any electrically conductive material suited for the use, such as steel or carbon materials. This alternate embodiment may be used to indicate changes in belt tension caused by load changes or by normal wear, allowing adjustment thereof by use of a tensioning idler.

The preferred belt has an overall length sufficient for service in an elevator system or for use on forklifts. The strain gage aspect of the belt would alert a user to an overload condition through high strain or to potential degradation of condition of the tensile member, for example, failure of strands within a stranded tensile member.

FIG. 2 is a cross-sectional view of the belt. Belt 100 has an overall width w and an overall height h. The aspect ratio w/h of the preferred embodiment is generally in the range of 1 to 30, but may comprise any suited to the particular application. Tensile cords 10 are substantially parallel to each other along a length of the belt.

Jumpers 12 are shown between adjacent tensile members 10. Jumpers 12 comprise conductors and are a portion of the series circuit between the tensile members. The jumpers are embedded within the belt body 11 and are located at each end of the belt. A like set of jumpers (not shown) is present on the opposing end of the belt, also comprising a portion of the series circuit, see FIG. 1.

FIG. 3 is a cross-sectional view at line 3-3 in FIG. 1. Clamp M2 engages an end of the belt 100 adjacent to protrusions 13, 14. In the preferred embodiment, protrusions 13, 14 extend across a width w of the belt. A single protrusion may also be used, for example, protrusion 13. Protrusions 13, 14 provide a positive mechanical engagement for the clamp to the belt to prevent the belt from being pulled through the clamp when it is under load L. Protrusions may also be used at the other end of the belt (not shown) in a like manner as shown in FIG. 3.

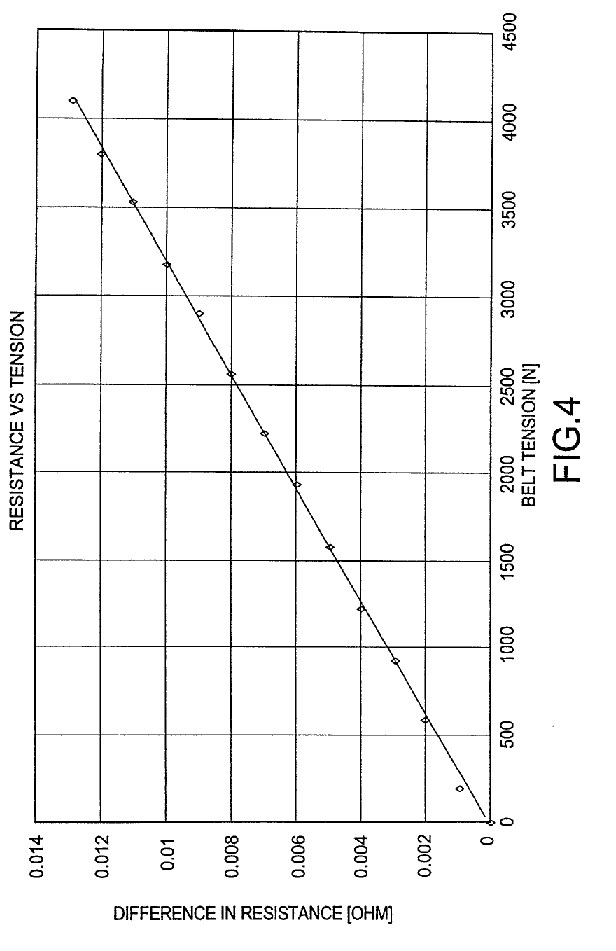

FIG. 4 is a graph of the resistance of a tensile member versus belt tension. The example depicted in the graph comprises a belt having ten steel cords 10 that are serially connected. The y-axis depicts the increase in resistance over a given base value for R1. The base value for R1 is measured in the unstressed condition. One can see that the resistance increases generally linearly with the increase in tension or load. One can appreciate that the resistance would continue to increase with load until one or all of the tensile cords fails. Upon failure of a tensile cord the resistance goes to ∞ ω.

Compilation of the resistance readings over time would be a helpful tool in identifying belt maintenance intervals or to predict failures.

Although a form of the invention has been described herein, it will be obvious to those skilled in the art that variations may be made in the construction and relation of parts without departing from the spirit and scope of the invention described herein.

We claim:

1. A lifting belt comprising:
an elastomeric body;
at least one conducting tensile member having a resistance and extending within the body; and
the conducting tensile member having a first lead and second lead for making a connection to an electrical circuit.

2. The belt as in claim 1, wherein the belt is endless and the belt further comprises sides extending along a length of the belt.

3. The belt as in claim 1, wherein the belt comprises a length having opposing ends.

4. The belt as in claim 1 further comprising:
an electrical circuit, the electrical circuit comprising
a voltage bridge for measuring a conducting tensile member resistance change.

5. The belt as in claim 3 further comprising:
a plurality of parallel conducting tensile members extending through the body along a major axis, each conducting tensile member electrically connected in series to an adjacent conducting tensile member whereby a series circuit is formed.

6. The belt as in claim 5, wherein the elastomeric body is an electrical insulator to prevent an electrical contact between adjacent conducting tensile members.

7. The belt as in claim 2, wherein the first lead and the second lead each extend on a belt side for contacting a conductor.

8. The belt as in claim 6, wherein the elastomeric body has a dielectric constant in the range of 1.5-10.0.

9. A lifting belt system comprising:
an elastomeric body having opposing ends;
at least one tensile member extending within the body along an axis and having a resistance;
the tensile member having a lead at each end connected to an electrical circuit; and
the electrical circuit for measuring a voltage change across the tensile member.

10. The system as in claim 9 wherein the electrical circuit further comprises:
a voltage bridge whereby a strain change in the tensile member is detected.

11. The system as in claim 9, wherein the elastomeric body is an electrical insulator to prevent an electrical contact between adjacent tensile members.

12. The system as in claim 9, wherein the elastomeric body has a dielectric constant in the range of 1.5-10.0.

13. The system as in claim 9 further comprising a protrusion on at least one end of the belt for engagement with a mounting device.

14. The system as in claim 5 further comprising a protrusion on at least one end of the belt for connection to a mounting device.
